(19) United States
(12) Patent Application Publication
(10) Pub. No.: US 2009/0088009 A1
(43) Pub. Date: Apr. 2, 2009

(54) ELECTRONIC APPARATUS AND CONNECTOR MOUNTED THEREOF

(75) Inventors: LUNG DAI, Tu-Cheng (TW); SHIH-LUNG HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,013

(22) Filed: Dec. 29, 2007

(30) Foreign Application Priority Data
Sep. 28, 2007 (CN) 200710201896.X

(51) Int. Cl. H01R 12/00

(52) U.S. Cl. 439/79

(57) ABSTRACT

A connector includes a main body, a first input contact, a second input contact, and a plurality of output contacts. The main body includes a first surface and a second surface. The first input contact and the second input contact project out from the first surface and extend in a first direction. The plurality of output contacts project out from the second surface and extend in a second direction. The second direction forms an acute angle with respect to the first direction.

### BACKGROUND

1. Field of the Invention

The present invention generally relates to electronic apparatuses, and more particularly, relates to an electronic apparatus mounted with a connector.

2. Description of Related Art

Connectors are used to connect cables or electronic apparatuses for providing communications, data transfer functions, and power connections. Various connectors such as universal serial bus (USB), high definition multimedia interface (HDMI), and D-subminiature (D-SUB) connectors are used for different purposes.

Such connectors are characterized in that they are usually mounted on an end portion of a printed circuit board (PCB). The connectors may be electrically connected to an external device such as keyboards, mice, modems, etc.

Typically, each connector includes a main body which is mounted with a plurality of input contacts and output contacts. The output contacts are securely soldered to the PCB. The input contacts may be coupled to the external devices via cables.

Normally, the input contacts projects perpendicularly to a surface or a wall of the main body. Because the cable, connected to the connector, may be freestanding the weight of the cable, such that the cable is often bent at an angle with respect to the main body. If the cable is bent too sharply, the electrical connection between the cable and the input contacts may become unreliable. In some cases, the cable may need to be unplugged and re-plugged several times to get a reliable connection, as such, the metallic wires in the cable may be bent or broken resulting in an unusable cable.

Therefore, what is desired in the industry is to provide a connector that is capable of providing a reliable electrical connection between the cable and the input contacts of the connector.

### SUMMARY

Accordingly, a connector is provided. The connector includes a main body, a first input contact, a second input contact, and a plurality of output contacts. The main body includes a first surface and a second surface. The first input contact and the second input contact project out from the first surface and extend in a first direction. The plurality of output contacts project out from the second surface and extend in a second direction. The second direction forms an acute angle with respect to the first direction. Moreover, a printed circuit board assembly and an electronic apparatus mounted with the connector are provided accordingly.

### BRIEF DESCRIPTION OF THE DRAWINGS

FIG. 1 is a partially broken side view of an electronic apparatus with a connector mounted thereof in accordance with an exemplary embodiment.

FIG. 2 is a perspective view of the connector in FIG. 1.

FIG. 3 is a side view of the connector in FIG. 1.

FIG. 4 is a using state view of the electronic apparatus in FIG. 1.

### DETAILED DESCRIPTION

Reference will now be made in detail to the exemplary embodiments of the display apparatus, examples of which are illustrated in the accompanying drawings.

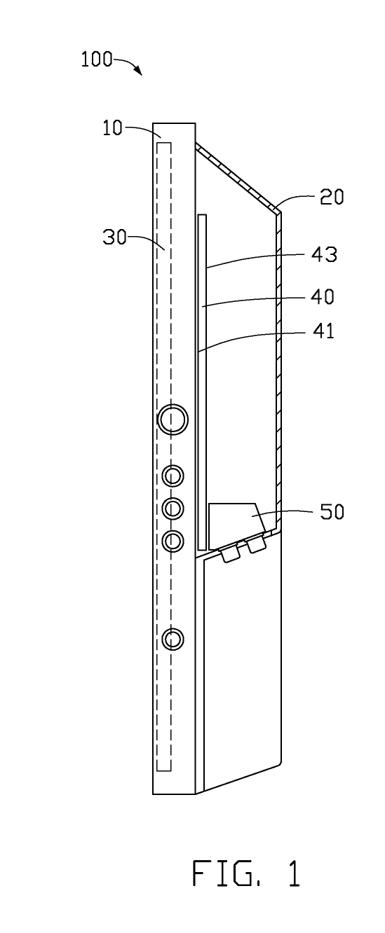

Referring to FIG. 1, an electronic apparatus 100 can be used in computers, televisions, and so on. The electronic apparatus 100 includes a first part 10 and a second part 20. The first part 10 and the second part 20 can be assembled together to enclose various components. In the embodiment, for example, a display panel 30, a printed circuit board 40 mounted with a connector 50 of the electronic apparatus 100 are enclosed by the first part 10 and the second part 20.

The printed circuit board 40 includes two parallelly arranged side surfaces, i.e., the first side surface 41 and the second side surface 43. The connector 50 is mounted adjacent an edge of the second side surface 43.

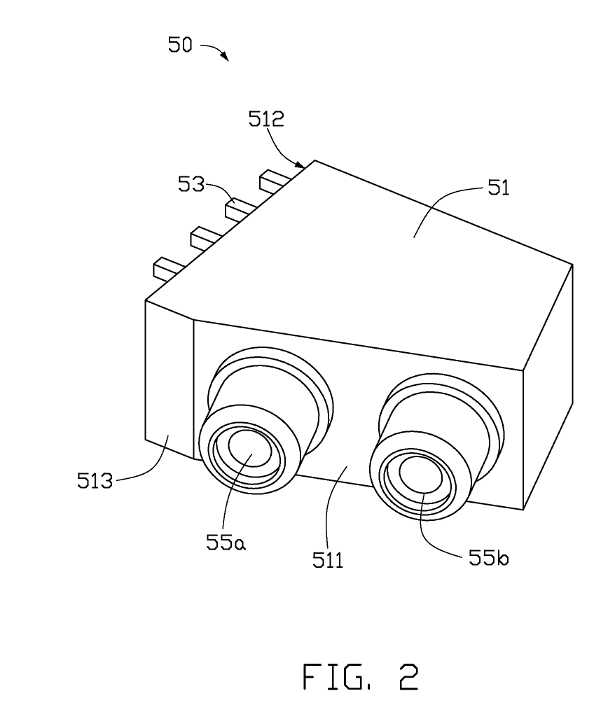

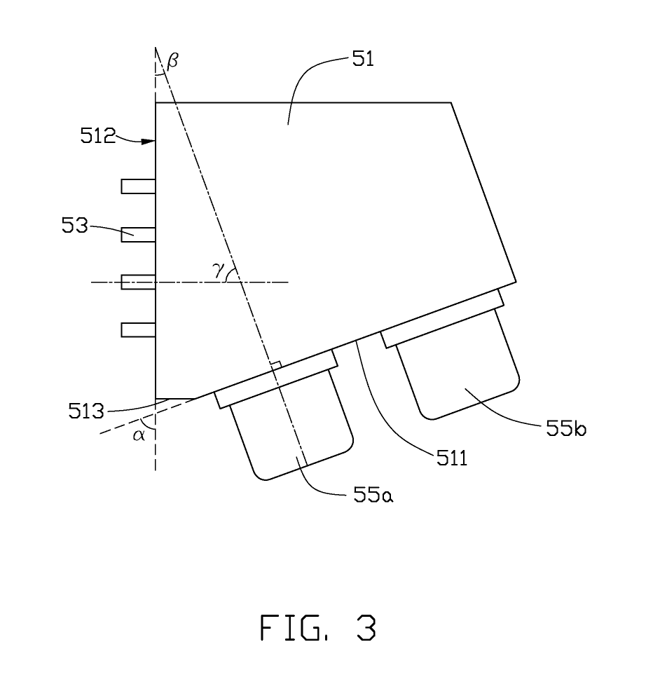

Referring to FIGS. 2, 3, the connector 50 includes a main body 51, a first input contact 55a, a second input contact 55b, and a plurality of output contacts 53. The first input contact 55a and the second input contact 55b are electrically coupled to the plurality of output contacts 53 by an internal circuitry (not illustrated) accommodated in the main body 51 and various components such as resistors, capacitors, integrated chips, and so on, electrically coupled between the input contacts 55a, 5b and the output contacts 53.

The main body 51 is a polyhedron and includes a first surface 511, a second surface 512, and a third surface 513. The first input contact 55a and the second input contact 55b projects out from the first surface of the main body 51, and extend in a first direction, as indicated by a dashed line a1, perpendicular to the first surface 511. The output contacts 53 project out from the second surface 512, and extend in a second direction, as indicated by a dashed line a2, perpendicular to the second surface 512. The dashed lines a1 and a2 intersect with each other to form an acute angle γ. The dashed line a1 forms an acute angle β with the second surface 512. In the embodiment, the acute angle β is 20 degrees. The acute angle β also can be other degrees selected in a range from about 10 degrees to about 45 degrees.

The first surface 511 is at an acute angle α, relative to the second surface 512, equaling the acute angle γ. As the acute angle γ is a complementary angle to the acute angle β, the acute angle γ may be 70 degrees or other value selected in a range from about 45 degrees to about 80 degrees. The third surface 513 is connected between the first surface 511 and the second surface 512. The third surface 513 extends perpendicularly to the second surface 512 in an opposite direction that the output contacts 53 extend.

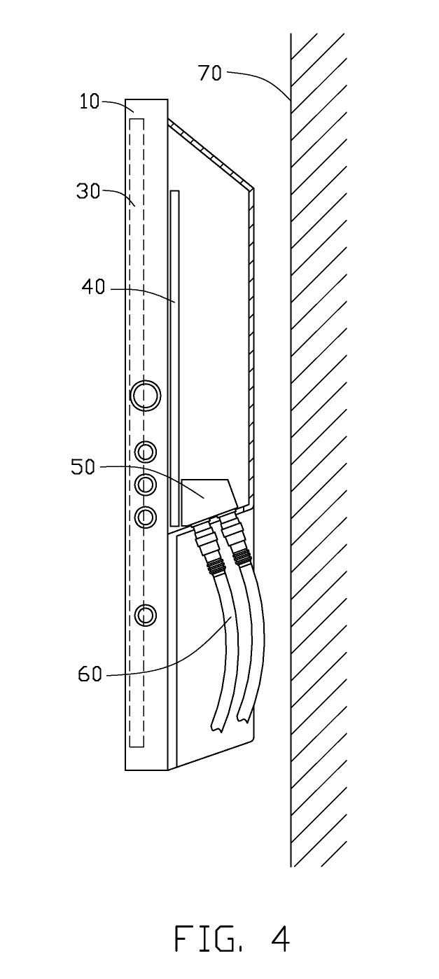

Referring to FIG. 4, in assembly, the connector 50 is coupled to the PCB 40 by inserting the plurality of output contacts 53 into corresponding through holes (not shown) defined in the PCB 40. The connector 50 is soldered to the PCB 40. The second surface 512 is aligned parallelly with the second side surface 43 of the PCB 40. Therefore, the first input contact 55a and the second input contact 55b form an acute angle β with respect to the PCB 40. The first input contact 55a and the second input contact 55b extend outward from an opening (not shown) defined in the second part 20. A cable 60 then can be connected to the first input contact 55a and the second input contact 55b for providing electrical connection between the electronic apparatus 100 and external devices (not shown).

As the exemplary embodiment described above, the first input contact 55a and the second input contact 55b of the connector extend obliquely with respect to the PCB 40, such that by attaching the connector 50 to the PCB 40, an acute angle is formed between the input contact and the PCB 40. As a result, the cable 60, when electrically connected to the first input contact 55a and the second input contact 55b, bends slightly as compared to the first input contacts 55a and the second input contact 55b projecting vertically from the PCB, thus, the electrical connection is more reliable.

In use, the electronic device 100 may be a host machine of a desktop computer. When the host machine 100 is pushed against a wall 70, the connector 50 is prevented from hitting the wall 70 because the first input contact 55a and the second input contact 55b is slanted with respect to the PCB 40.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A connector, comprising:
a main body comprising a first surface and a second surface;
an input contact, the input contact projecting out from the first surface and extending in a first direction; and
a plurality of output contacts, the plurality of output contacts projecting out from the second surface and extending in a second direction, the supplementary angle formed with respect to the angle between the first direction in which the input contact extends and the second direction in which anyone of the plurality of output contact extends is an acute angle;
wherein the acute angle is in a range from 45 degrees to 80 degrees.

2. The connector as claimed in claim 1, wherein the input contact projects perpendicularly to the first surface.

3. The connector as claimed in claim 1, wherein the plurality of output contacts project perpendicularly to the second surface.

4. The connector as claimed in claim 1, wherein the acute angle is 70 degrees.

5. (canceled)

6. The connector as claimed in claim 3, wherein the connector comprises a third surface, the third surface connects between the first surface and the second surface, the third surface projects perpendicularly to the second surface.

7. A printed circuit board assembly, comprising:
a printed circuit board;
a connector mounted on the printed circuit board, the connector comprising:
a main body comprising a first surface and a second surface;
a plurality of input contacts projecting out from the first surface; and
a plurality of output contacts projecting out from the second surface, the first surface forming an acute angle with respect to the second surface;
wherein the acute angle is in a range from 45 degrees to 80 degrees.

8. The printed circuit board assembly as claimed in claim 7, wherein the plurality of input contacts projects perpendicularly to the first surface.

9. The printed circuit board assembly as claimed in claim 7, wherein the plurality of output contacts project perpendicularly to the second surface.

10. The printed circuit board assembly as claimed in claim 7, wherein the acute angle is 70 degrees.

11. (canceled)

12. The printed circuit board assembly as claimed in claim 7, wherein the connector further comprises a third surface, the third surface connects between the first surface and the second surface, the third surface projects perpendicularly to the second surface.

13. An electronic apparatus, comprising:
a first part;
a second part;
a printed circuit board received in an accommodating space defined by assembling the first part and the second part; and
a connector detachably mounted on the printed circuit board, the connector comprising:
a main body comprising a first surface and a second surface;
a first input contact and a second input contact protruding out from the first surface; and
a plurality of output contacts, the plurality of output contacts protruding out from the second surface, the first surface and the second surface forming an acute angle with each other;
wherein the acute angle is in a range from 45 degrees to 80 degrees.

14. The electronic apparatus as claimed in claim 13, wherein the first input contact and the second input contact protrude perpendicularly to the first surface.

15. The electronic apparatus as claimed in claim 13, wherein the output contacts protrude perpendicularly to the second surface.

16. The electronic apparatus as claimed in claim 13, wherein the acute angle is 70 degrees.

17. (canceled)

18. The electronic apparatus as claimed in claim 13, wherein the connector further comprises a third surface, the third surface connects between the first surface and the second surface, the third surface projects perpendicularly to the second surface.
